(19) United States
(12) Patent Application Publication
(10) Pub. No.: US 2006/0007432 A1
(43) Pub. Date: Jan. 12, 2006

(54) Optical arrangement for obtaining a measurement signal for power measurement in lasers

(76) Inventors: Peter Heist, Jena (DE); Uwe Kutschki, Jena (DE)

Correspondence Address: JORDAN AND HAMBURG LLP, 122 EAST 42ND STREET, SUITE 4000, NEW YORK, NY, 10168, US

(21) Appl. No.: 10/999,783

(22) Filed: Nov. 29, 2004

(30) Foreign Application Priority Data
Nov. 27, 2003 (DE) 103 55 866.7

(51) Int. Cl. G01J 1/42

(52) U.S. Cl. 356/218

(57) ABSTRACT

In an optical arrangement for obtaining a measurement signal for power measurement in lasers, the object is to reliably prevent laser radiation-induced contamination of the optically active surfaces with comparatively simple means, so that the optical properties of the surfaces, in particular the reflection coefficient, remain unchanged for a longer period of time than in the past. A beam splitter that is arranged on the laser beam axis and that directs a fraction of the laser beam onto a sensor by reflection, has optically active surfaces for the reflection that limit an opposing contamination-free, hermetically sealed inner space that is highly transmissive for the wavelength of the laser radiation.

The invention relates to an optical arrangement for obtaining a measurement signal for power measurement in lasers with a beam splitter that is arranged on the laser beam axis and that directs a fraction of the laser beam onto a sensor by reflex formation on optically active surfaces.

Important characteristic values in continuously emitting lasers and highly repetitive pulsed lasers with pulse repetition rates in the kHz range and higher (quasi-continuous or q-cw) are the power and the mean power of the laser beam and, generally, pulse energy in pulsed lasers with lower repetition rates.

The goal in laser design is frequently oriented toward measuring these characteristic values in the laser itself, especially the measurement values for regulating and stabilizing the laser power or laser pulse energy.

A power monitor integrated in the laser should use only a small portion of the laser power generated in order not to limit unnecessarily the power of the usable radiation leaving the laser and should measure precisely over long periods of time.

For satisfying the first requirement, generally optical beam splitters are placed in the beam path; they split off a fraction (typically a few percent or less) of the generated laser beam by transmission or reflection as measurement signal.

If the measurement signal is to be generated by transmission, mirrors made of dielectric layer systems are available. While the useful radiation of high power is reflected, the lower power radiation fraction to be measured penetrates the multilayer system.

Power measurement using this functional principle is disadvantageous in terms of long-term stability. Although the optical properties of the layer system have only a minor dependence on exterior factors such as humidity, temperature, and power of the striking radiation, which do not have a significant effect in the highly reflecting radiation portion, these minor changes do lead to substantial fluctuations in the radiation fraction to be measured. This has particularly negative effects when the measurement signal is used to stabilize the usable laser power.

A measuring device known from DE 43 36 589 C1 with a sensor and an electronic evaluation and display devices provides for laser power measurement a beam splitter that is shielded by screens with a beam entry opening and an exit opening and that is highly transmitting for the laser wavelength; two beams as fractions of the laser radiation are reflected to the sensor from its beam splitter surfaces.

Even with this technical solution, it is not always possible to satisfy the second requirement, particularly when laser-induced changes in the reflection factor occur at the beam splitter as a main problem for a power measurement that is stable over the long term.

The disadvantage connected with this results from the requirement that the measurement signal S received by the sensor should be proportional to the useful power P emitted by the laser, where S=k×P. Normally the laser manufacturer calibrates the proportionality factor k by measuring the external power P with a calibrated power meter. Each additional calibration or check of calibration can be associated with higher costs because the laser is frequently used in applications in which access for an external power measurement is rendered more difficult because of beam guide optics or other components (e.g., encapsulation of the beam) or is undesirable due to production processes.

Therefore, the proportionality factor k, once calculated, should remain unchanged for the longest periods possible over the service life of the laser; that is recalibration intervals should be as long as possible.

Particularly in the ultraviolet (UV) spectrum, changes that occur in the transmission and reflection coefficient due to the formation and depositing of micro-particles on the optical surfaces, which formation and depositing are induced by the laser itself, are a major problem in terms of power measurement that is stable over a long term.

U.S. 2003/0007537 cites as a reason impurities that are in the environment of the optical components, that are generally present in the gaseous phase, and that are frequently organic. They can have many different origins, such as e.g. out-gases from materials such as O-ring seals, adhesives, cable insulators, or other sources. The impurities even occur when the laser interior is hermetically sealed against the external environment.

The suggestion, for reducing impurities of optical components that are housed in a closed housing in a gas atmosphere, to draw off gas from the atmosphere and send it in multiple successive steps through suitable particle and active carbon filters, is not satisfactory due to its great complexity, especially since the method requires that the saturation of the filters used be monitored continuously.

Starting at this point, it is the object of the invention to improve the arrangement identified in the foregoing such that the laser radiation-induced contamination of the optically active surfaces is reliably prevented using relatively simple means so that the optical properties of the surfaces, in particular the reflection coefficient, remain unchanged over a longer period of time than in the past.

In accordance with the invention, the object is achieved in an arrangement of the type identified in the foregoing in that the surfaces that are optically active for the reflection limit an opposing contamination-free, hermetically sealed inner space that is highly transmissive for the wavelength of the laser radiation.

In one preferred embodiment of the invention, it is provided that the contamination-free, hermetically sealed inner space has opposing beam entry and beam exit windows as space limits, and that their window surfaces that face one another form the optically active surfaces.

By constructing a closed contamination-free microvolume that protects the optically active surfaces from particle deposits in a uniform and highly effective manner, a power monitor can be integrated in the laser that power monitor not only reduces to a small degree the laser power provided for use, but that also has a long service life, since the causes of fluctuations in the reflection coefficient, which particularly impact the weak measurement signal, are prevented at their source.

In contrast to housing all of the optical components of a laser in a common housing, when constructing the microvolume, optics assembly joining techniques can be applied that avoid the sources of contamination.

Additional advantageous embodiments are explained in greater detail using the schematic drawings.

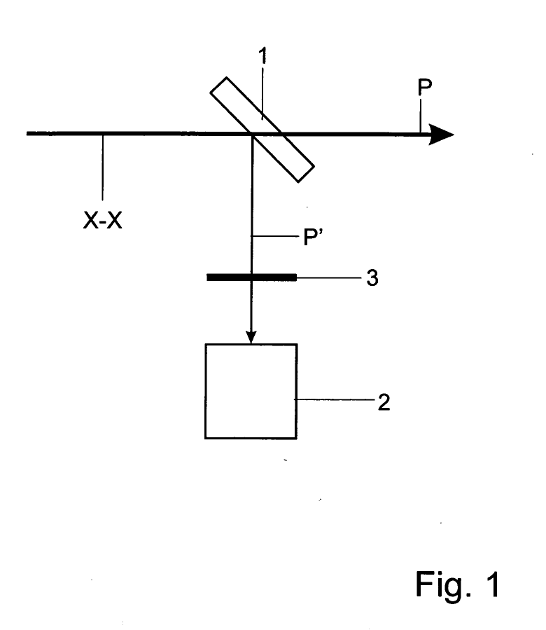

FIG. 1 illustrates an optical arrangement for forming a measurement signal for power measurement in a laser beam.

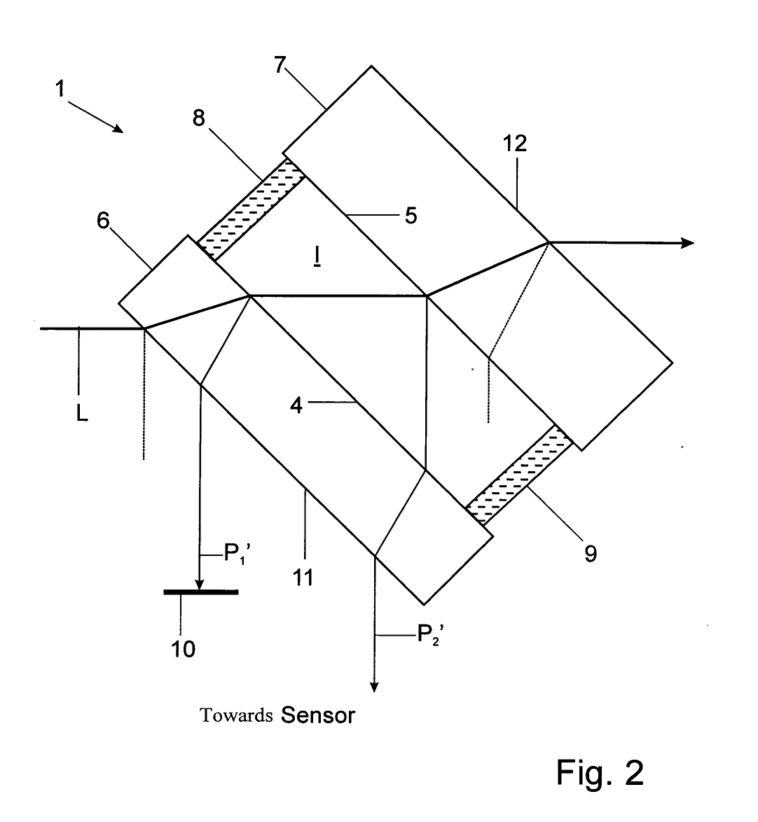

FIG. 2 illustrates an optical component acting as beam splitter for the optical arrangement in accordance with FIG. 1 that has an enclosed contamination-free micro-volume for forming a measurement signal.

The optical arrangement illustrated in FIG. 1 contains, arranged on the laser beam axis X-X, a beam splitter 1, which directs a fraction of the laser beam power as a measurement signal to e.g. a sensor 2 that is embodied as a photodiode and that includes evaluation electronics (not shown), while the rest of the laser beam power remains nearly completely available as useful power P. For illustration purposes, only the reflex P′ formed by the front surface of the beam splitter 1 that forms the measurement signal is illustrated. Beam mixing and/or reducing optical components such as e.g. diffusers or filters can be arranged between the beam splitter 1 and the sensor 2, which is symbolized by an illustrated component 3.

In this arrangement, P′=r×P, where r<<1 for the reflection coefficient, so that P′<<P.

For obtaining a measurement signal in the form of a reflex, in accordance with FIG. 2 an optical component provided as a beam splitter 1 for the inventive arrangement has opposing optically active surfaces 4 and 5 that limit a contamination-free, hermetically sealed inner space I that is highly transmissive for the laser wavelength.

By design, the optically active surfaces 4 and 5 form window surfaces, that face one another, of a beam entry window and a beam exit window 6 and 7. The two windows 6 and 7, together with a pair of opposing walls 8 and 9, enclose the inner space I, whereby the sealing means used do not form sources of out-gases. Known joining techniques from optics assembly technology, such as e.g. friction or diffusion welding can be considered for this. For ensuring a contamination-free atmosphere, the inner space I is preferably filled with an ultrapure inert gas such as e.g. a noble gas or it is evacuated.

As a rule, laser radiation is linearly polarized so that the optically active surfaces 4 and 5 do not have to be provided with a special dielectric coating for generating the reflex for the measurement signal. Although changes in the reflection coefficient r that result from a degradation of the coating can be avoided by this, in practice it has been demonstrated that even precluding changes in dielectric coating systems and constancy in the refraction coefficient and in the angle of incidence cannot preclude changes to the reflection coefficient r. Therefore, in accordance with the invention it is suggested that a closed contamination-free microvolume be constructed that protects the optically active surfaces 4 and 5 from contamination.

The laser radiation L enters through the beam entry window 6 and leaves the optical component through the beam exit window 7. If the wavelength of the laser radiation is in the UV range, both windows 6 and 7 should preferably comprise synthetic quartz glass or CaF2.

What is crucial for the function of the optical component is the occurrence of a reflex P1′ on the optically active surface 4 during the transition of the beam entry window 6 to the inner space I and the occurrence of another reflex P2′ on the optically active surface 5 during the transition from the inner space I to the beam exit window 7.

Using a screen, one of the two reflexes P1′ or P2′ can be obstructed when it strikes the sensor 2. This measure is illustrated by a screen labeled 10 between the reflex P1′ and the sensor 2. Another suitable measure is applying an anti-reflection coating to one of the optically active surfaces 4 or 5, which suppresses the formation of one of the two reflexes P1′ or P2′.

Furthermore, the window surfaces 11 and 12, which face away from one another, of the beam entry window 6 and beam exit window 7 can be provided with an anti-reflection coating effective for the laser wavelength, which elevates the overall transmission of the optical component and prevents the formation of interfering reflexes.

1. An optical arrangement for measuring a laser signal with a sensor, the laser providing an axial beam, the arrangement comprising:
a beam splitter, said beam splitter having first and second optically active surfaces, said beam splitter being arranged on the laser beam axis, said beam splitter partially reflecting the laser beam towards the sensor; and
said beam splitter having a container between said optically active surfaces, said container being contamination-free and hermetically sealed, said container being capable of transmitting a preselected wavelength, said wavelength corresponding to a wavelength of the laser beam.

2. The arrangement of claim 1, further comprising:
beam entry and beam exit windows, said entry and exit windows being mutually opposing and having opposing internal surfaces, said internal surfaces facing one another and defining said optically active surfaces.

3. The arrangement of claim 2, wherein said beam entry and exit windows have respective opposing exterior surfaces, said exterior surfaces facing away from one another, said exterior surfaces comprising an anti-reflection coating, said coating blocking said preselected wavelength.

4. The arrangement of claim 1, wherein said beam splitter splits said beam into a plurality of components and reflects said components towards the sensor, said arrangement further comprising a screen, said screen preventing at least one of said plurality of beam components from striking the sensor.

5. The arrangement of claim 1, wherein said beam splitter splits said beam into a plurality of components and reflects said components towards the sensor, said arrangement further comprising an anti-reflection coating, said coating being located against one of said optically active surfaces, said coating preventing at least one of said plurality of beam components from striking the sensor.

6. The arrangement of claim 4, wherein said screen is separate from said beam splitter and the sensor, said screen being arranged between said beam splitter and the sensor.

7. The arrangement of claim 2, wherein said beam entry and exit windows comprise a UV-permeable material.

8. The arrangement of claim 1, wherein said container comprises an ultra-pure inert gas.

9. The arrangement of claim 1, wherein said container comprises a vacuum chamber.
